(19) United States
(12) Patent Application Publication
(10) Pub. No.: US 2013/0000091 A1
(43) Pub. Date: Jan. 3, 2013

(54) Expander For Mounting An Idle End of a Roller Blind to a Roller Tube

(76) Inventor: Norman Wills, Mississauga (CA)

(21) Appl. No.: 13/173,798

(22) Filed: Jun. 30, 2011

(51) Int. Cl. B23P 11/00

(52) U.S. Cl. 29/282

(57) ABSTRACT

There is provided a system for correcting errors in cutting the length of a roller tube by effectively expanding the length of the roller tube which is to be mounted to an idle end to form a roller blind. The system includes at least one flat disk coaxially mounted between the idle end and one end of the roller tube. The flat disk has a thickness equal to a desired length of expansion of the roller tube. The flat disk has a central opening dimensioned to receive the idle end.

### FIELD OF THE INVENTION

The invention relates generally to roller blinds and in particular idle ends for mounting an end of a roller blind tube to a mounting bracket

### BACKGROUND OF THE INVENTION

Roller blinds always include an elongated roller tube having opposite ends which is mounted between support brackets. The support brackets are generally suspended at the top of a window frame so that the roller blind drapes over the window. The roller blind generally has a clutch end positioned at one end of the roller tube and an idle end positioned at the opposite end of the roller tube. The roller tube is suspended to the support brackets at the clutch end and idle end.

Installing a roller blind often starts by measuring the width of the window and cutting the roller tube to match the width of the window. The roller tube is generally an elongated aluminum tube which can be easily cut at the installation site. It will be appreciated that given the long length of the desired roller tube, it is quite possible to make a small error in the measuring or cutting of the roller tube. Generally, measuring and cutting errors range between a few millimeters to a few centimeters. If the roller tube is accidentally cut two centimeters too long, it is a trivial matter to shorten the roller tube. However, if the roller tube is cut two centimeters too short, then the wrongly cut piece of roller tube will have to be discarded. In addition to wasting the material cost of the discarded section of roller tube, cutting the roller tube too short can seriously decrease the efficiency of the installation because time will be wasted in mounting a wrongly sized roller tube. A system which would correct cutting errors in roller tubes would therefore decrease costs and increase efficiency.

### SUMMARY OF THE INVENTION

In accordance with one aspect of the present invention, there is provided a system for correcting errors in cutting the length of a roller tube by effectively expanding the length of a roller tube which is to be mounted to an idle end to form a roller blind. The system includes at least one flat disk coaxially mounted between the idle end and one end of the roller tube. The flat disk has a thickness equal to a desired length of expansion of the roller tube. The flat disk has a central opening dimensioned to receive the idle end.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is a perspective view of an idle end expander made in accordance with the present invention for use with an idle end and a roller tube.

FIG. 2 is a perspective view of two idle end expanders made in accordance with the present invention for use with an idle end and a roller tube.

FIG. 3 is a side view of an idle end coupled to a roller tube without the spacer portion of the present invention.

FIG. 4 is a side view of two idle end expanders made in accordance with the present invention and mounted between an idle end and a roller tube.

FIG. 5 is a side view of an idle end expander made in accordance with the present invention for use with an idle end and a roller tube.

FIG. 6 is a side view of two idle end expanders made in accordance with the present invention for use with an idle end and a roller tube.

In the drawings like characters of reference indicate corresponding parts in the different figures.

### DETAILED DESCRIPTION OF THE INVENTION

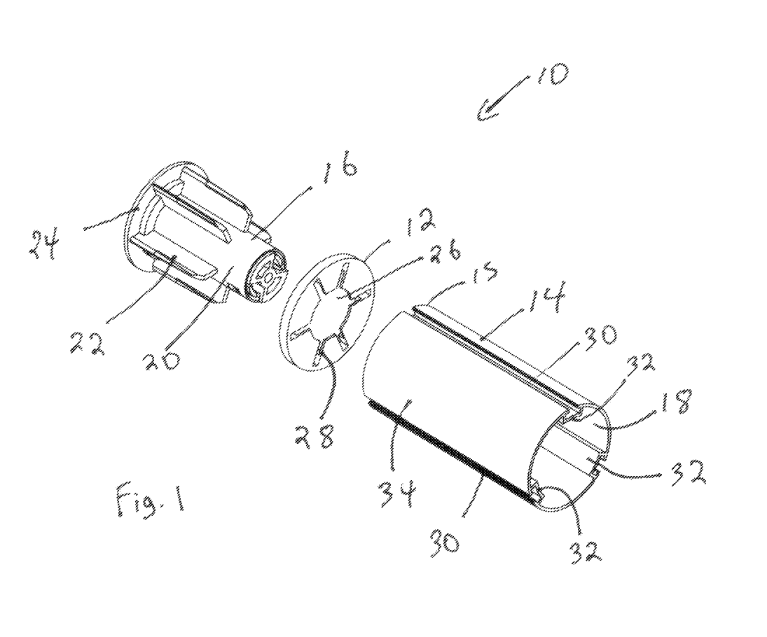

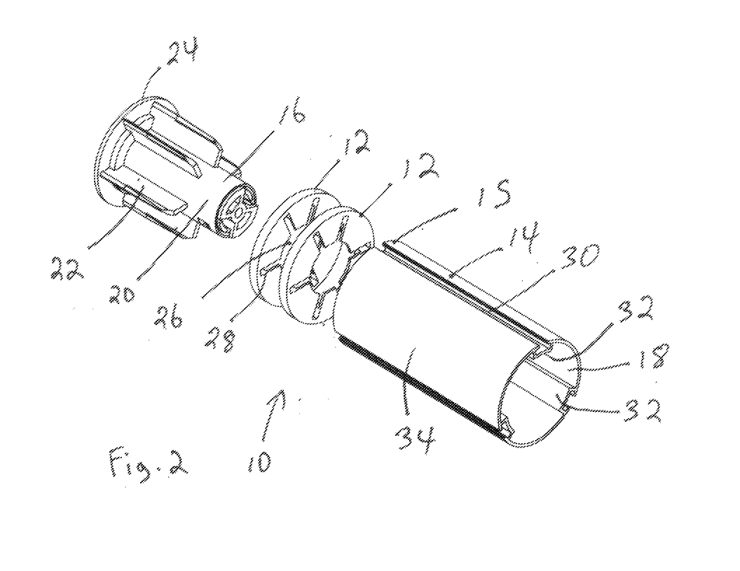

Referring firstly to FIGS. 1 and 2, an expander system for use with a roller tube and idle end is shown generally as item 10 and consists of a flat circular member 12 which is configured to mount coaxially between idle end 16 and roller tube 14 so as to compensate for the roller tube being too short. Roller tube 14 is generally an elongated extruded aluminum tube having an interior 18 and an outside surface 34. Grooves 30 are formed on the outside surface 34 of roller tube 14 and channels 32 project into interior 18. The length of roller tube 14 is generally several feet and is cut to suite the length of the desired roller blind (not shown) which is to be made using the roller tube. Idle end 16 is dimensioned to fit within end 15 of roller tube 14. Idle end 16 has barrel portion 20, flange portion 24 and a plurality of fins 22 radiating from barrel portion 20. Fins 22 are dimensioned to permit idle end 16 to fit snuggly within interior 18 of roller tube 14. Fins 22 are spaced apart such that channels 32 fit between adjacent fins to permit the idle end to fit all the way in roller tube 14 such that flange 24 lies flush against end 15. Spacer 12 is a disc shaped plastic member having an external diameter equal to the external diameters of roller tube 14 and flange portion 24 of idle end 16. Spacer 12 has central opening 26 which is dimensioned and configured to fit over and receive barrel portion 20 of idle end 16. Slots 28 are formed in spacer 12 and configured such that they can be aligned with and receive fins 22 of idle end 16. When idle end 16, spacer 12 and roller tube 18 are coaxially aligned, spacer 12 can be snuggly fitted between flange 24 and end 15, thereby effectively lengthening roller tube 14 by the thickness of spacer 12. As best seen in FIG. 2, it is possible to further increase the effective length of roller tube 14 by using a plurality of identical spacers. The length by which roller tube 14 is increased is a sum of the thicknesses of the spacers used.

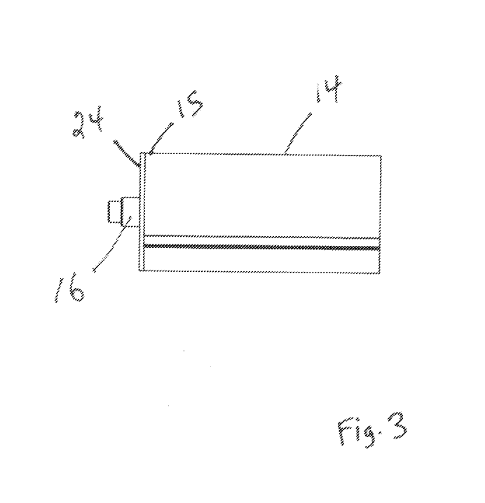

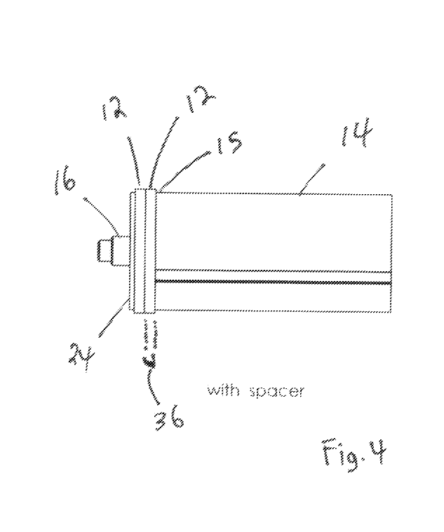

Referring now to FIG. 3, without spacer 12, idle end 16 can be mounted to end 15 of roller tube 14 such that flange portion 24 of the idle end snuggly abuts end 15. This is the configuration which is likely to be used in the event that roller tube 14 is cut to the correct size and need not be expanded. As best seen in FIG. 4, each spacer 12 has a thickness 36. As shall be discussed below, preferably, thickness 36 is selected to be between 2 mm to 6 mm. Adding one spacer 12 increases the effective length of roller tube 14 by the amount of thickness 36. Adding several spacers increases the effective length of roller tube 14 by the cumulative total thicknesses of all the spacers. Hence, in the example shown in FIG. 4, if each spacer 12 has a thickness of 5 mm, then the effective length of roller tube 14 will be increased by 1 cm.

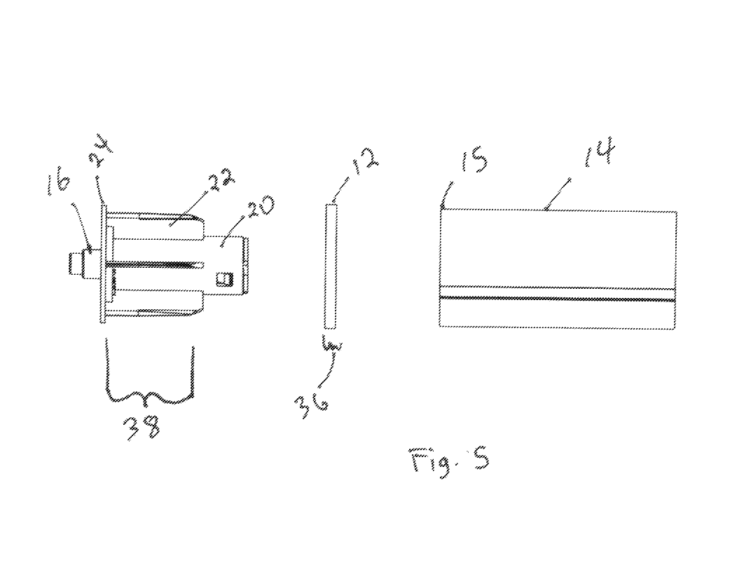

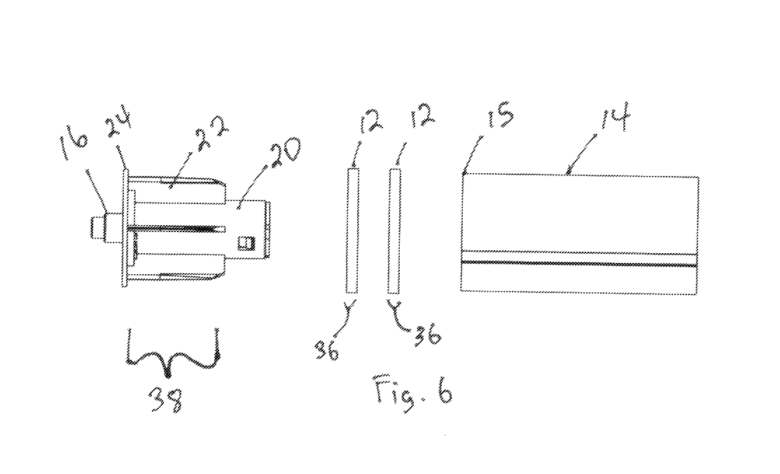

Spacers 12 are intended to be used in order to correct measuring errors when roller tube 14 is cut. It has been discovered that a majority of cutting/measuring errors are in the range of only one or two centimeters. Since the actual cutting error is essentially random, each spacer is preferably in the range of between 2 to 6 mm in thickness to enable one or two standardized spacer sizes to be used. This eliminates the need for carrying a plurality of different sized spacers. As seen in FIGS. 5 and 6, fins 22 of idle end 16 have a length 38 of over 4 centimeters, which is significantly longer than similar fins on standard idle end used with roller blinds. The increased length of fins 22 is to accommodate a larger number of spacers 12 and therefore enable several spacers to be mounted to the idle end. It will be appreciated that spacers 12 do not help secure end 15 of roller tube 14. Roller tube 14 is supported on fins 22, so adding several spacers 12 between flange 24 and end 15 actually decreases the amount of contact between fins 22 and the roller tube. To compensate for this decreased contact between fins 22 and roller tube 14, fins 22 are made several centimeters longer to ensure that sufficient contact between the roller tube and the idle end is maintained even when several spacers 12 are used.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims

Therefore, what is claimed is:

1. A system for effectively expanding the length of a roller tube mounted to an idle end, the system comprising at least one flat disk coaxially mounted between the idle end and one end of the roller tube, the flat disk having a thickness equal to a desired length of expansion of the roller tube, the flat disk having a central opening dimensioned to receive the idle end.

2. The system for effectively expanding the length of a roller tube as defined in claim 1 further comprising a plurality of identical flat disks, each of the flat disks having a thickness equal to the desired length of expansion divided by the number of identical flat disks.

3. The system for effectively expanding the length of a roller tube as defined in claim 1 wherein the idle end has a barrel portion, a flange portion and a plurality of fins radiating from the barrel portion and wherein the flat disk includes a central opening dimensioned and configured to receive the barrel portion, the central opening further comprising a plurality of slots configured to receive the fins.

4. The system for effectively expanding the length of a roller tube as defined in claim 2 wherein the idle end has a barrel portion, a flange portion and a plurality of fins radiating from the barrel portion and wherein the flat disk includes a central opening dimensioned and configured to receive the barrel portion, the central opening further comprising a plurality of slots configured to receive the fins.

5. The system for effectively expanding the length of a roller tube as defined in claim 3 further comprising a plurality of identical flat disks, each of the flat disks having a thickness equal to the desired length of expansion divided by the number of identical flat disks.

6. The system for effectively expanding the length of a roller tube as defined in claim 4 wherein the fins have a length which is longer than the combined thicknesses of the flat disks.

7. The system for effectively expanding the length of a roller tube as defined in claim 3 wherein the fins have a length which is longer than the combined thicknesses of the flat disks.
